(19) United States
(12) Patent Application Publication
(10) Pub. No.: US 2024/0405458 A1
(43) Pub. Date: Dec. 5, 2024

(54) COMPRESSIVE TERMINAL PAD MOUNTING FACE

(71) Applicant: Hubbell Incorporated, Shelton, CT (US)

(72) Inventor: Brian Royal Ellis, Dover, NH (US)

(73) Assignee: Hubbell Incorporated, Shelton, CT (US)

(21) Appl. No.: 18/327,949

(22) Filed: Jun. 2, 2023

Related U.S. Application Data
(63) Continuation of application No. PCT/US21/61392, filed on Dec. 1, 2021.

(51) Int. Cl. H01R 11/05; H01R 11/01; H01R 43/042

(52) U.S. Cl. CPC H01R 11/05; H01R 11/01; H01R 43/042

(57) ABSTRACT

A mounting assembly includes a mounting body having a first slot and a second slot, a terminal pad being in the first slot, and a rail being in the second slot. The mounting body being deformed around the terminal pad and the rail so that a mechanical and electrical connection is formed between the terminal pad and the rail.

### CROSS REFERENCE TO RELATED APPLICATIONS

This application is a continuation of International Application PCT/US21/61392 filed Dec. 1, 2021, which claims the benefit under 35 USC § 119 of U.S. Patent Application Ser. No. 63/121,423 filed Dec. 4, 2020, the entire contents of both are incorporated herein by reference.

### BACKGROUND

### 1. Field of the Invention

The present disclosure is related to establishing conductive connections to rails. More particularly, the present disclosure is related to a compressive terminal pad mounting face that permanently deforms in a way that envelopes and secures a terminal pad to establish an irreversible mechanical and electrical bond between the terminal pad and a rail.

### 2. Description of Related Art

Customers in the rail market are searching for irreversible connections that are capable of withstanding stress due to vibration. Exothermic processes currently provide irreversible welded connections, however they are expensive, slow, and subject installers to hazardous work environments. Other connections can use drilling; however, expensive diamond drill bits are often required to drill through rails. Though compressive technologies do exist for installing a conductor directly to flanges, these technologies are not capable of scaling to the conductor sizes required for rail applications (up to 1000 KCMIL) as the resulting profile would not fit in existing tool technologies. Alternatively, solutions that include the process of installing a mounting face directly to the flange, and then fastening a terminal pad directly to that mounting face cannot be considered fully irreversible as it is reliant on mechanical fasteners. When subjected to vibrations such as those experienced in rail environments, mechanical fasteners tend to relax and unwind, compromising the mechanical and electrical integrity of the connection. Additionally, these mechanical connections are subject to a number of other challenges including cross threading, crevice corrosion, and improper installation torque.

Accordingly, it has been determined by the present disclosure that there is a continuing need for rail connection apparatuses that overcome, alleviate, and/or mitigate one or more of the aforementioned and other deleterious effects of prior devices.

### SUMMARY

The present disclosure provides a compressive terminal pad mounting face that allows a connector profile to permanently deform in a way that envelopes and secures a terminal pad, establishing a truly irreversible mechanical and electrical bond between the terminal pad and the rail without subjecting the installer to hazardous working conditions.

A mounting assembly is provided that includes a mounting body having a first slot and a second slot, a terminal pad being in the first slot, and a rail being in the second slot. The mounting body being deformed around the terminal pad and the rail so that a mechanical and electrical connection is formed between the terminal pad and the rail.

In some embodiments either alone or together with any one or more of the aforementioned and/or after-mentioned embodiments, the mounting body forms an S-shape.

In some embodiments either alone or together with any one or more of the aforementioned and/or after-mentioned embodiments, the mounting body forms a top member connected to a first side member on a first side and the top member having a free end opposite the first side member, where the first side member is connected to a middle member on a side opposite the top member and the middle member is connected to a second side member on a side opposite the first side member, where the second side member is connected to a bottom member on a side that is opposite the middle member, and where the bottom member has a free end on a side opposite the second side member.

In some embodiments either alone or together with any one or more of the aforementioned and/or after-mentioned embodiments, the first slot is formed in the top member, the first side member, the middle member and the second side member.

In some embodiments either alone or together with any one or more of the aforementioned and/or after-mentioned embodiments, the second slot is formed in the first side member, the middle member, the second side member and the bottom member.

In some embodiments either alone or together with any one or more of the aforementioned and/or after-mentioned embodiments, the top member has a capture feature that extends from the free end of the top member into the second slot.

In some embodiments either alone or together with any one or more of the aforementioned and/or after-mentioned embodiments, the top member has a release port formed in the first slot, and the top member has a thickness that is reduced at the release port.

In some embodiments either alone or together with any one or more of the aforementioned and/or after-mentioned embodiments, the middle member has a thickness that increase from the first side member to the second side member.

In some embodiments either alone or together with any one or more of the aforementioned and/or after-mentioned embodiments, the top member forms a space between the capture feature and the second side member that is smaller than the terminal pad.

In some embodiments either alone or together with any one or more of the aforementioned and/or after-mentioned embodiments, the top member is flat on a surface opposite the first slot.

In some embodiments either alone or together with any one or more of the aforementioned and/or after-mentioned embodiments, the top member is curved on a surface opposite the first slot.

In some embodiments either alone or together with any one or more of the aforementioned and/or after-mentioned embodiments, the mounting body has teeth formed inside the second slot on the middle member and the bottom member.

In some embodiments either alone or together with any one or more of the aforementioned and/or after-mentioned embodiments, the top member has at least one opening that receives a pin.

In some embodiments either alone or together with any one or more of the aforementioned and/or after-mentioned embodiments, the mounting member has an E-shape.

In some embodiments either alone or together with any one or more of the aforementioned and/or after-mentioned embodiments, the mounting body has a first side member and a second side member on opposite sides of a middle member with a first top member extending from the first side member and a second top member extending from the second side member forming the first slot, and the mounting body has a bottom member extending from the second side member so that the bottom member, the second side member, the middle member and the first side member form the second slot.

In some embodiments either alone or together with any one or more of the aforementioned and/or after-mentioned embodiments, the first top member and the second top member are curved.

A method for connecting a terminal pad to a rail is also provided that includes inserting a terminal pad in a first slot of a mounting body; inserting a rail in a second slot of the mounting body; and deforming the mounting body around the terminal pad and the rail so that a mechanical and electrical connection is formed between the terminal pad and the rail.

In some embodiments either alone or together with any one or more of the aforementioned and/or after-mentioned embodiments, the method can include contacting the mounting body with a first die and contacting the mounting with a second die prior to the deforming of the mounting body.

A die set is further provided that includes a first die for connecting to a crimping tool. The first die is configured to contact a first side of a mounting body. A second die is also included for connecting to the crimping tool. The second die is configured to contact a second side of a mounting body so that the first die and the second die apply forces in opposite directions to compress and deform the mounting body around a terminal pad and a rail forming a mechanical and electrical connection between the terminal pad and the rail.

The above-described and other features and advantages of the present disclosure will be appreciated and understood by those skilled in the art from the following detailed description, drawings, and appended claims.

### DESCRIPTION OF THE DRAWINGS

FIG. 1 is a front, perspective view of an exemplary embodiment of a compressive terminal pad mounting face of the present disclosure connected to a rail and a terminal pad;

FIG. 2 is a front, perspective view of the compressive terminal pad mounting face of FIG. 1;

FIG. 3 is a rear, perspective view of the compressive terminal pad mounting face of FIG. 1;

FIG. 4 is a front view of the compressive terminal pad mounting face of FIG. 1;

FIG. 5 is a perspective view of the terminal pad of FIG. 1;

FIG. 6 is a perspective view of the rail of FIG. 1;

FIG. 7 is a front, perspective view of a second embodiment of a compressive terminal pad mounting face of the present disclosure;

FIG. 8 is a front view of the compressive terminal pad mounting face of FIG. 7;

FIG. 9 is a partial front view of the compressive terminal pad mounting face of FIG. 7 that is modified and connected to the terminal pad;

FIG. 10 is a front, perspective view of a third embodiment of a compressive terminal pad mounting face of the present disclosure connected to the terminal pad and the rail;

FIG. 11 is a front view of the compressive terminal pad mounting face of FIG. 10;

FIG. 12 is a front, perspective view of the compressive terminal pad mounting face of FIG. 10;

FIG. 13 is a front, perspective view of a fourth embodiment of a compressive terminal pad mounting face of the present disclosure connected to the terminal pad;

FIG. 14 is a front view of the compressive terminal pad mounting face of FIG. 13;

FIG. 15 is a front, perspective view of the compressive terminal pad mounting face of FIG. 13;

FIG. 16 is a front, perspective view of a fifth embodiment of a compressive terminal pad mounting face of the present disclosure connected to the terminal pad;

FIG. 17 is a front view of the compressive terminal pad mounting face of FIG. 16;

FIG. 18 is a front, perspective view of the compressive terminal pad mounting face of FIG. 16;

FIG. 19 is a front, perspective view of a sixth embodiment of a compressive terminal pad mounting face of the present disclosure connected to the terminal pad;

FIG. 20 is a front, perspective view of the compressive terminal pad mounting face of FIG. 19;

FIG. 21 is a front view of the compressive terminal pad mounting face of FIG. 19;

FIG. 22 is a front, perspective view of a seventh embodiment of a compressive terminal pad mounting face of the present disclosure connected to the terminal pad;

FIG. 23 is a front, perspective view of the compressive terminal pad mounting face of FIG. 22;

FIG. 24 is a front view of the compressive terminal pad mounting face of FIG. 22;

FIG. 25 is a front, perspective view of an eighth embodiment of a compressive terminal pad mounting face of the present disclosure connected to the terminal pad;

FIG. 26 is a front, perspective view of the compressive terminal pad mounting face of FIG. 25;

FIG. 27 is a front view of the compressive terminal pad mounting face of FIG. 25;

FIG. 28 is a perspective view of a tool;

FIG. 29 is a side view of a first die; and

FIG. 30 is a side view of a second die.

### DETAILED DESCRIPTION

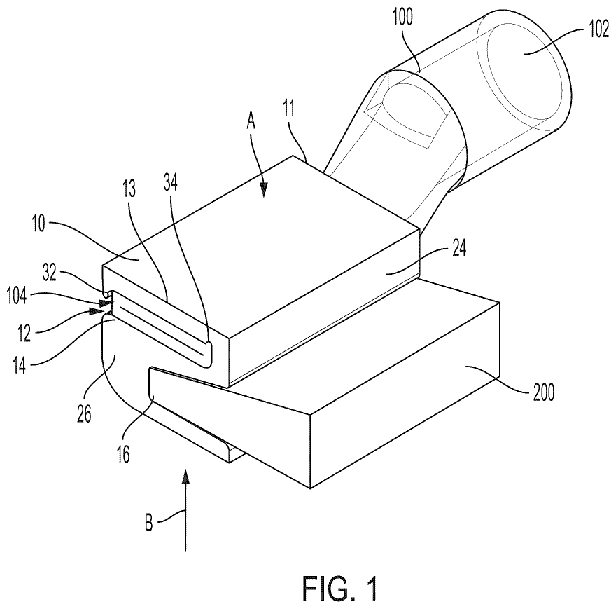

Referring to the drawings and in particular to FIG. 1, an exemplary embodiment of a compressive terminal pad mounting face according to the present disclosure is shown and is generally referred to by reference numeral 10 (“mounting 10”). Mounting 10 has a mounting body 12 that forms a first slot 14 and a second slot 16. First slot 14 is sized to receive a terminal pad 100 that is connected to a conductor. Second slot 16 is sized to receive a rail 200. Mounting body 12 is compressible to connect to terminal pad 100 and rail 200 forming a mechanical and electrical connection between terminal pad 100 and rail 200. Mounting 10 can be formed of a metal material, for example, annealed 110 copper.

The rail market has an interest in an irreversible, efficient, and safe conductor to rail connection as well as has a dissatisfaction with current market options. Rails include rails for use with trains. The size of typical conductors used in this application (up to 1000 KCMIL) presents a challenge. Current irreversible conductor to rail, flange, or bar designs are not able to scale in a way that could accommodate a conductor of this size, while still being installable with current compression tool technologies. By first installing a terminal pad 100 to an end of a conductor, mounting 10 is able to utilize the streamlined cross-section of terminal pad 100 in order to fit both terminal pad 100, as well as a rail 200, or a flange or bus, in a connector profile compact enough to be installed using standard compression tooling technologies. During installation, mounting 10 has the connector profile permanently deform in a way that ensures an irreversible connection between terminal pad 100 and rail 200, or flange, or bus.

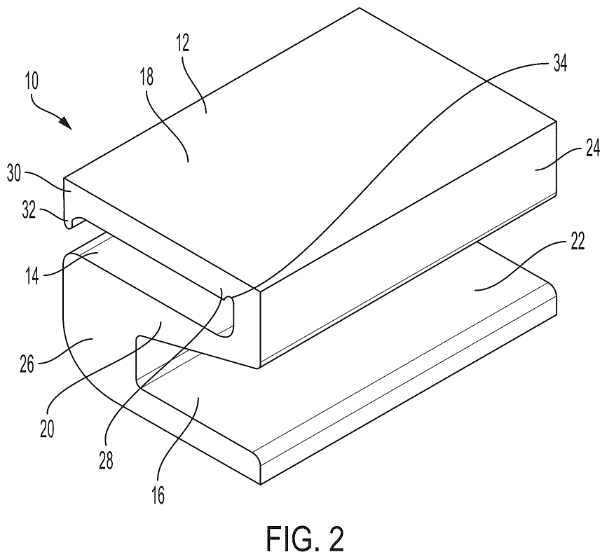

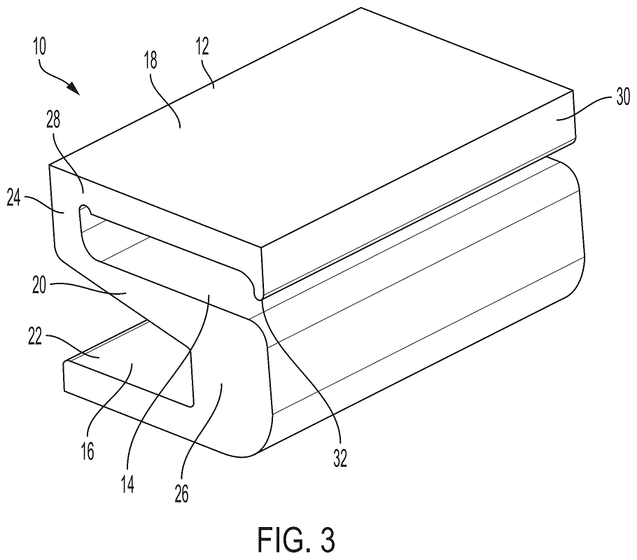

Referring to FIGS. 2 and 3, mounting body 12 has a top member 18, a middle member 20, and a bottom member 22. Top member 18 is connected to middle member 20 by a first side member 24. Middle member 20 is connected to bottom member 22 by a second side member 26. Top member 18, middle member 20, bottom member 22, first side member 24 and second side member 26 form a S-shape having first slot 14 and second slot 16 therein. Top member 18 has a first top edge 28 that connects with first side member 24 and a second top edge 30 that is opposite first top edge 28 that is free. Top member 18 has a capture feature 32 at second top edge 30 facing middle member 20. Top member 18 has a relief port 34 at a location where first top edge 28 meets first side member 24.

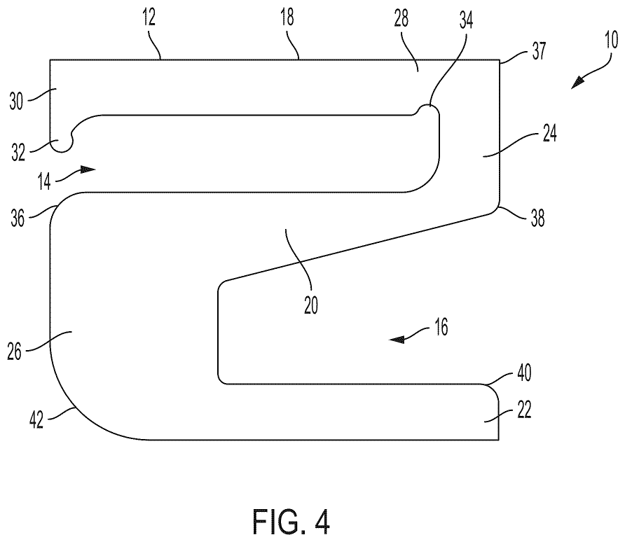

Referring to FIG. 4, relief port 34 extends into top member 18 so that top member 18 has a decreased thickness at relief port 34. Capture feature 32 extends from top member 18 so that mounting body 12 has an increased thickness at capture feature 32. Middle member 20 increases in thickness from first side member 24 to second side member 26 so that second slot 16 decreases in size. Second side member 26 has a greater thickness than first side member 24. Mounting body 12 has a top corner 37. Mounting body 12 has an inner first edge 36, an inner middle edge 38, an inner second edge 40, and a side bottom edge 42 that are all rounded.

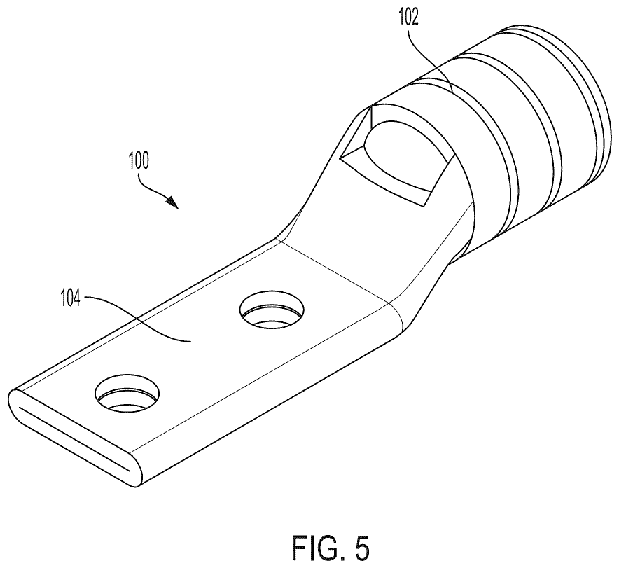

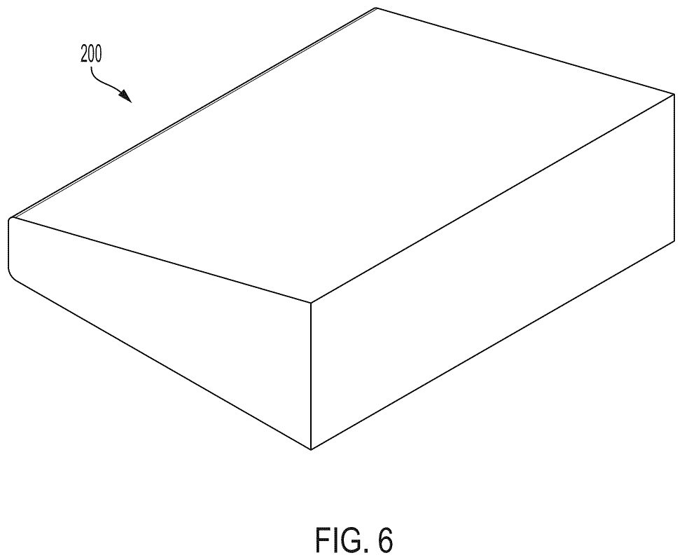

Referring to FIG. 1, in operation, mounting 10, as shown in FIG. 2, can be used with terminal pad 100, as shown in FIG. 5, and rail 200, as shown in FIG. 6. Terminal pad 100 has a receptacle portion 102 and a pad portion 104. Receptacle portion 102 connects to a conductor, for example, up to 1000 KCMIL (or up to about 1¼ inch) diameter conductor. Pad portion 104 of terminal pad 100 is inserted between top member 18, first side member 24, middle member 20, and second side member 26 of mounting 10. A space between capture feature 32 and second side member 26 is too small for pad portion 104 to fit therebetween. Pad portion 104 can be inserted between top member 18, first side member 24, middle member 20, and second side member 26 of mounting 10 from a first end 11 or a second end 13 of mounting 10. Alternatively, the space between capture feature 32 and second side member 26 may be sized large enough for sliding pad portion 104 between capture feature 32 and second side member 26. Second slot 16 receives rail 200. Second slot 16 is sized and shaped complementary to rail 200.

Once pad portion 104 of terminal pad 100 is inserted into first slot 14 and rail 200 is inserted into second slot 16, then a force is applied simultaneously in a first direction A and a second direction B that is opposite to direction A to compress and deform mounting 10 from a pre-deformed configuration as shown in FIG. 2 to a deformed configuration, as shown in FIG. 1, to connect terminal pad 100 and rail 200 together. Relief port 34 aids with movement of top member 18 towards second side member 26 allowing second top edge 30 of top member 18 that is free to rotate toward second side member 26 if needed as mounting 10 is deformed. Capture feature 32 maintains pad portion 104 of terminal pad 100 in place prior to and after deforming mounting 10 from sliding out of the space between capture feature 32 and second side member 26. Mounting 10 is deformed around terminal pad 100 and rail 200 so that terminal pad 100 is compressed between top member 18, first side member 24, middle member 20 and second side member 26 maintaining terminal pad 100 in place in mounting 10 and rail 200 is compressed between bottom member 22, second side member 26, middle member 20 and first side member 24 to maintain rail 200 in place in mounting 10. Advantageously, once rail 200 is inserted into second slot 16, the S-shape of mounting 10 allows a user to hold mounting 10 against rail 200 as leverage while pushing terminal pad 100 into first slot 14 and during compression. The flat surfaces of top member 18, middle member 20 and first side member 24 provide desirable contact with terminal pad 100 for conduction. Alternatively, a single force could be applied in either direction A or direction B to deform mounting 10.

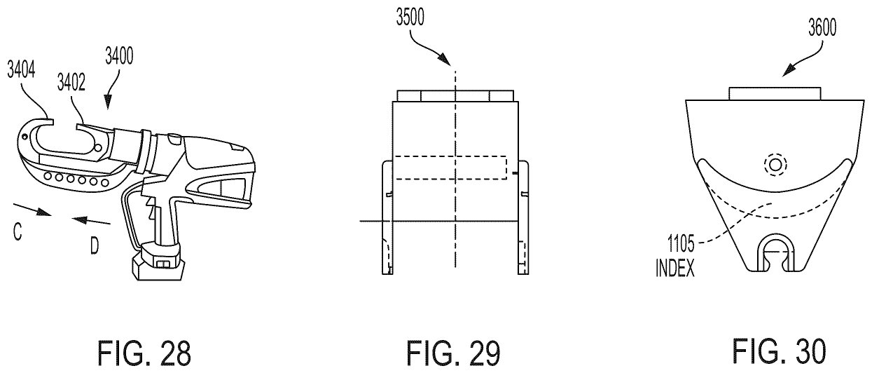

Compression of mounting 10 in first direction A and second direction B simultaneously to connect terminal pad 100 and rail 200 is achievable by current compression tool technologies, for example, a crimping tool 3400 referred to as a Patriot® 15 ton C-head manufactured by Burndy® as shown in FIG. 28 that is used with the dies 3500, 3600 of FIGS. 29 and 30. Crimping tool 3400 has opposite members 3402, 3404. Each of dies 3500, 3600 is placed on one of members 3402, 3404. One of dies 3500, 3600 is placed against top member 18 and the other of dies 3500, 3600 is placed against bottom member 22 of mounting 10, so that crimping tool 3400 is activated to move members 3402, 3404 together to move dies 3500, 3600 together in directions C and D simultaneously to deform mounting 10 connecting terminal pad 100 and rail 200.

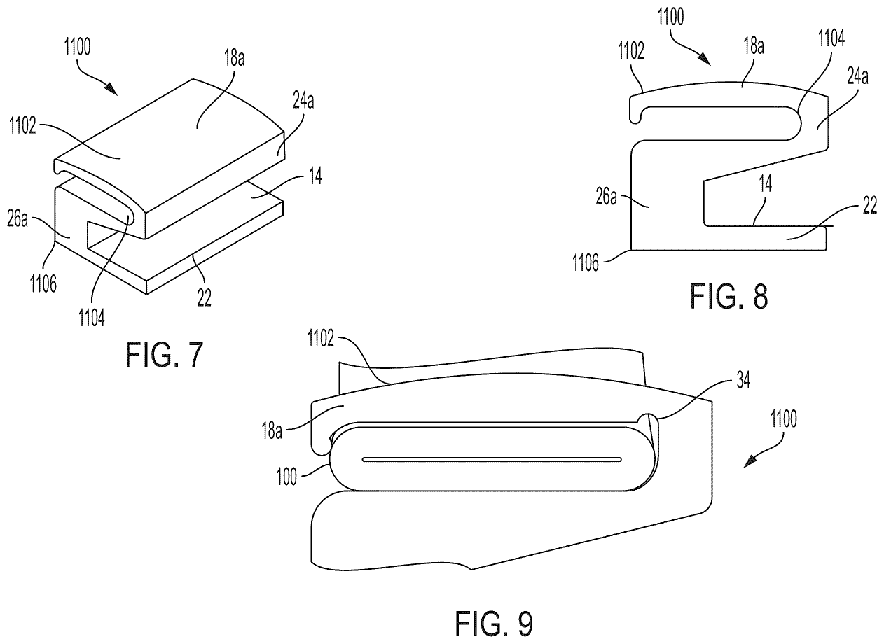

Referring to FIGS. 7-9, a second embodiment of a compressive terminal pad mounting face according to the present disclosure is shown and is generally referred to by reference numeral 1100 (“mounting 1100”). Mounting 1100 is the same as mounting 10 except top member 18 is modified to top member 18a that has a curved surface 1102, first side member 24 is modified to first side member 24a that replaces relief port 34 with a curved shape 1104, and second side member 26 is modified to second side member 26a that forms a corner 1106 with bottom member 22. During deformation of mounting 1100, top member 18a that has a curved surface 1102 deforms in a way that generates a seam of increased stress along the midpoint of mounting 1100, resulting in a more secure mechanical connection between terminal pad 100 and rail 200. Features of mounting 1100 that are the same as mounting 10 use the same reference numerals. Alternatively, as shown in FIG. 9, mounting 1100 can be modified to include relief port 34.

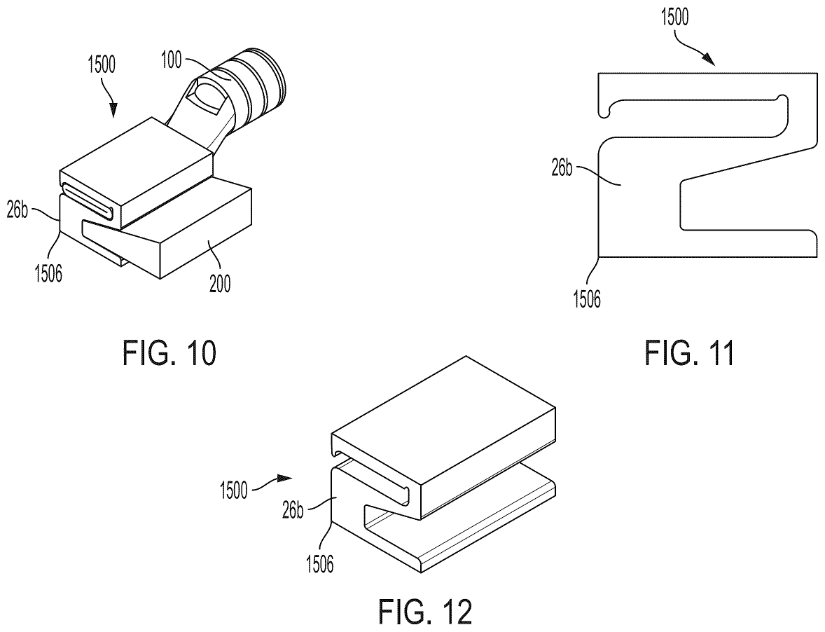

Referring to FIGS. 10-12, a third embodiment of a compressive terminal pad mounting face according to the present disclosure is shown and is generally referred to by reference numeral 1500 (“mounting 1500”). Mounting 1500 is the same as mounting 10 except second side member 26 is modified to second side member 26b that forms a corner 1506 with bottom member 22. Corner 1506 results in an increase in the flat surface area of bottom member 22 as such increasing the flat surface area available for contact from dies 3500 and 3600 during deformation of mounting 1500. Features of mounting 1500 that are the same as mounting 10 use the same reference numerals.

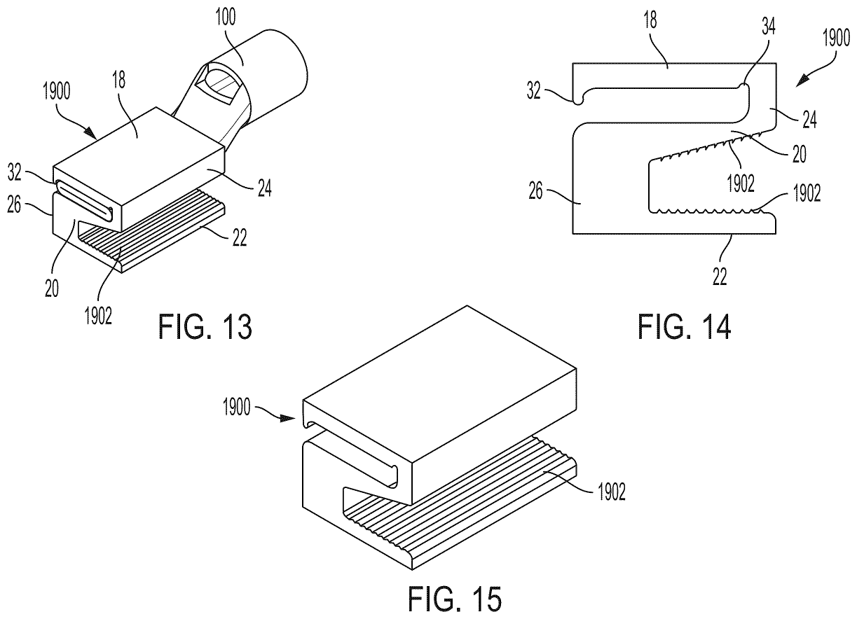

Referring to FIGS. 13-15, a fourth embodiment of a compressive terminal pad mounting face according to the present disclosure is shown and is generally referred to by reference numeral 1900 (“mounting 1900”). Mounting 1900 is the same as mounting 1500 except teeth 1902 are added to middle member 20 and bottom member 22. Teeth 1902 assist with gripping of rail 200 to help maintain the connection between mounting 1900 and rail 200 after mounting 1900 is deformed. Features of mounting 1900 that are the same as mounting 10 use the same reference numerals. Teeth 1902 can be added to any of the embodiments herein.

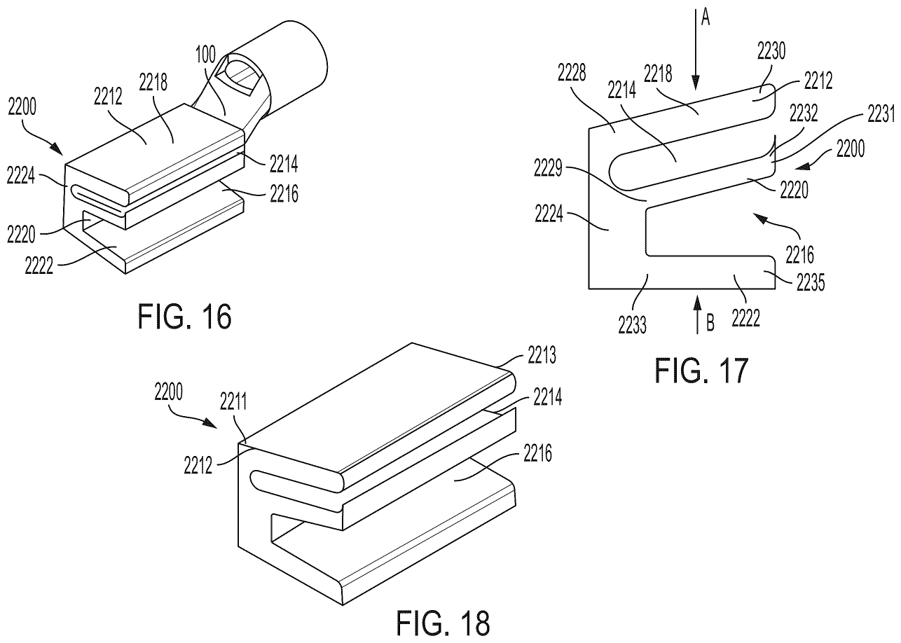

Referring to FIGS. 16-18, a fifth embodiment of a compressive terminal pad mounting face according to the present disclosure is shown and is generally referred to by reference numeral 2200 (“mounting 2200”). Mounting 2200 has a mounting body 2212 that forms a first slot 2214 and a second slot 2216. First slot 2214 is sized to receive terminal pad 100 that is connected to the conductor. Second slot 2216 is sized to receive rail 200. Mounting body 2212 is compressible to connect to terminal pad 100 and rail 200 forming a mechanical and electrical connection between terminal pad 100 and rail 200. Mounting 2200 can be formed of a metal material, for example, annealed 110 copper.

First slot 2214 and second slot 2216 form a top member 2218, a middle member 2220, and a bottom member 2222 that extend from a side member 2224. Top member 2218, middle member 2220, bottom member 2222, and side member 2224 form an E-shape having first slot 2214 and second slot 2216 therein. Top member 2218 has a first top edge 2228 that connects with side member 2224 and a second top edge 2230 that is opposite first top edge 2228 that is free. Middle member 2220 has a first middle edge 2229 that connects with side member 2224 and a second middle edge 2231 that is opposite first middle edge 2229 that is free. Middle member 2220 has a capture feature 2232 at second middle edge 2231 facing top member 2218. Bottom member 2222 has a first bottom edge 2233 that connects with side member 2224 and a second bottom edge 2235 that is opposite first bottom edge 2233 that is free. First slot 2214 is shaped complimentary to pad portion 104 of terminal pad 100. Second slot 2216 is shaped complimentary to rail 200.

Referring to FIG. 16, in operation, mounting 2200 can be used with terminal pad 100, as shown in FIG. 5, and rail 200, as shown in FIG. 6. Pad portion 104 of terminal pad 100 is inserted between top member 2218, side member 2224 and middle member 2220 of mounting 2200. A space between capture feature 2232 and top member 2218 is too small for pad portion 104 to fit between capture feature 2232 and top member 2218. Pad portion 104 can be slide between top member 2218, side member 2224 and middle member 2220 of mounting 2200 from a first end 2211 or a second end 2213 of mounting 2200. Alternatively, the space between capture feature 2232 and top member 2218 may be sized large enough for sliding pad portion 104 between capture feature 2232 and top member 2224. Second slot 2214 receives rail 200. Second slot 2214 is sized and shaped complementary to rail 200.

Once pad portion 104 of terminal pad 100 is inserted between top member 2218, side member 2224 and middle member 2220 of mounting 2200 and rail 200 is inserted in second slot 2214, then a force is applied simultaneously in first direction A and second direction B that is opposite to direction A to compress and deform mounting 2200 from a pre-deformed configuration as shown in FIG. 17 to a deformed configuration, as shown in FIG. 16, to connect terminal pad 100 and rail 200 together. Capture feature 2232 maintains pad portion 104 of terminal pad 100 in place prior to and after deforming mounting 2200 from sliding out of the space between capture feature 2232 and top member 2218. Mounting 2200 is deformed around terminal pad 100 and rail 200 so that terminal pad 100 is compressed between top member 2218, side member 2224, and middle member 2220 maintaining terminal pad 100 in place in mounting 2200 and rail 200 is compressed between bottom member 2200, side member 2224 and middle member 2220 to maintain rail 200 in place in mounting 2200. The flat surfaces of top member 2218, middle member 2220 and side member 2224 provide desirable contact with terminal pad 100 for conduction. Alternatively, a single force could be applied in either direction A against top member 2218 or direction B against bottom member 2222.

Compression of mounting 2200 in first direction A and second direction B simultaneously to connect terminal pad 100 and rail 200 is achievable by current compression tool technologies, for example, crimping tool 3400 referred to as a Patriot® 15 ton C-head manufactured by Burndy® as shown in FIG. 28 that is used with the dies 3500, 3600 of FIGS. 29 and 30. One of dies 3500, 3600 is placed on each of members 3402, 3404. One of dies 3500, 3600 is placed against top member 2218 and the other of dies 3500, 3600 is placed against bottom member 2222 of mounting 2200, so that crimping tool 3400 is activated to move members 3402, 3404 together to move dies 3500, 3600 together simultaneously in directions C and D to deform mounting 2200 connecting terminal pad 100 and rail 200.

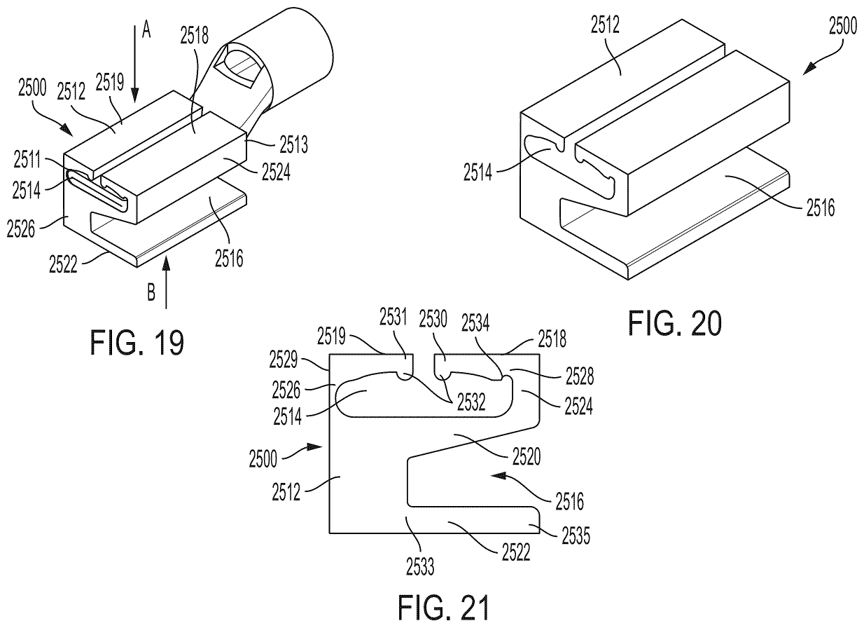

Referring to FIGS. 19-21, a sixth embodiment of a compressive terminal pad mounting face according to the present disclosure is shown and is generally referred to by reference numeral 2500 (“mounting 2500”). Mounting 2500 has a mounting body 2512 that forms a first slot 2514 and a second slot 2516. First slot 2514 is sized to receive terminal pad 100 that is connected to the conductor. Second slot 2516 is sized to receive rail 200. Mounting body 2512 is compressible to connect to terminal pad 100 and rail 200 forming a mechanical and electrical connection between terminal pad 100 and rail 200. Mounting 2500 can be formed of a metal material, for example, annealed 110 copper.

First slot 2514 is formed by a middle member 2520, a first top member 2518 that extends from a first side member 2524, and a second top member 2519 that extends from a second side member 2526. Both first side member 2524 and second side member 2526 extend from opposite ends of middle member 2520. Middle member 2520 increases in size from first side member 2524 to second side member 2526. Each of first top member 2518 and second top member 2519 have a capture feature 2532. First top member 2518 has a relief port 2534 that extends into top member 2518 so that top member 2518 has a decreased thickness at relief port 2534. Second slot 2516 is formed by first side member 2524, middle member 2520, second side member 2526 and a bottom member 2522 that extends from second side member 2526. First top member 2518 has a first top edge 2528 that connects with first side member 2524 and a second top edge 2530 that is opposite first top edge 2528 that is free. Second top member 2519 has a first top edge 2529 that connects with second side member 2526 and a second top edge 2531 that is opposite first top edge 2529 that is free. Bottom member 2522 has a first bottom edge 2533 that connects with second side member 2526 and a second bottom edge 2535 that is opposite first bottom edge 2533 that is free. First slot 2514 is shaped complimentary to pad portion 104 of terminal pad 100. Second slot 2516 is shaped complimentary to rail 200.

Referring to FIG. 19, in operation, mounting 2500 can be used with terminal pad 100, as shown in FIG. 5, and rail 200, as shown in FIG. 6. Pad portion 104 of terminal pad 100 is inserted between first top member 2518, second top member 2519, first side member 2524, second side member 2526, and middle member 2520 of mounting 2500. A space between second top edge 2530 of first top member 2518 and second top edge 2531 of second top member 2519 is too small for pad portion 104 to fit therebetween. Pad portion 104 can be slide between first top member 2518, second top member 2519, first side member 2524, second side member 2526, and middle member 2520 of mounting 2500 from a first end 2511 or a second end 2513 of mounting 2500. Alternatively, the space between second top edge 2530 of first top member 2518 and second top edge 2531 of second top member 2519 may be sized large enough for inserting pad portion 104 therebetween. Second slot 2514 receives rail 200. Second slot 2514 is sized and shaped complementary to rail 200.

Once pad portion 104 of terminal pad 100 is inserted between first top member 2518, second top member 2519, first side member 2524, second side member 2526, and middle member 2520 of first slot 2514 and rail 200 is inserted in second slot 2516, then a force is applied to first top member 2518 and second top member 2519 in a first direction A and simultaneously in a second direction B that is opposite to direction A to bottom member 2522 to compress and deform mounting 2500 from a pre-deformed configuration as shown in FIG. 21 to a deformed configuration, as shown in FIG. 19, to connect terminal pad 100 and rail 200 together. Capture features 2532 maintain pad portion 104 of terminal pad 100 in place prior to and after deforming mounting 2500 from sliding out of mounting 2500. Relief port 2534 aids with movement of top member 2518 towards middle member 2520 allowing second top edge 2530 of top member 2518 to be free to rotate toward middle member 2520 if needed as mounting 2500 is deformed. Mounting 2500 is deformed around terminal pad 100 and rail 200 so that terminal pad 100 is compressed between first top member 2518, second top member 2519, first side member 2524, second side member 2526, and middle member 2520 maintaining terminal pad 100 in place in mounting 2500 and rail 200 is compressed between bottom member 2522, first side member 2524, second side member 2526 and middle member 2520 to maintain rail 200 in place in mounting 2500. The surfaces of first top member 2518, second top member 2519, first side member 2524, second side member 2526, and middle member 2520 provide desirable contact with terminal pad 100 for conduction. Alternatively, a single force could be applied in either direction A against first top member 2518 and second top member 2519 or direction B against bottom member 2522.

Compression of mounting 2500 in first direction A and second direction B simultaneously to connect terminal pad 100 and rail 200 is achievable by current compression tool technologies, for example, crimping tool 3400 referred to as a Patriot® 15 ton C-head manufactured by Burndy® as shown in FIG. 28 that is used with the dies 3500, 3600 of FIGS. 29 and 30. Each of dies 3500, 3600 is placed on one of members 3402, 3404. One of dies 3500, 3600 is placed against first top member 2518 and second top member 2519 and the other of dies 3500, 3600 is placed against bottom member 2522 of mounting 2500, so that crimping tool 3400 is activated to move members 3402, 3404 together to move dies 3500, 3600 together simultaneously in directions C and D to deform mounting 2500 connecting terminal pad 100 and rail 200.

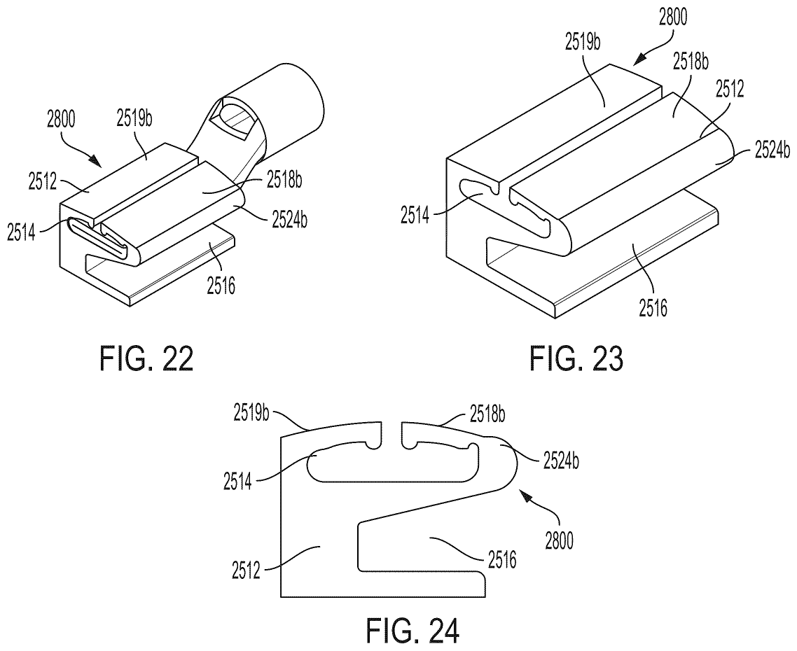

Referring to FIGS. 22-24, a seventh embodiment of a compressive terminal pad mounting face according to the present disclosure is shown and is generally referred to by reference numeral 2800 (“mounting 2800”). Mounting 2800 is the same as mounting 2500 except first top member 2518 and second top member 2519 are modified to first top member 2518b and second top member 2519b that are curved and first side member 2524 is modified to first side member 2524b that is curved. When compared to mounting 2500, the deformation of mounting 2800 results in the compressive force of dies 3500 and 3600 to be translated to a larger surface area of rail 200, improving the mechanical connection. Features of mounting 2800 that are the same as mounting 2500 use the same reference numerals.

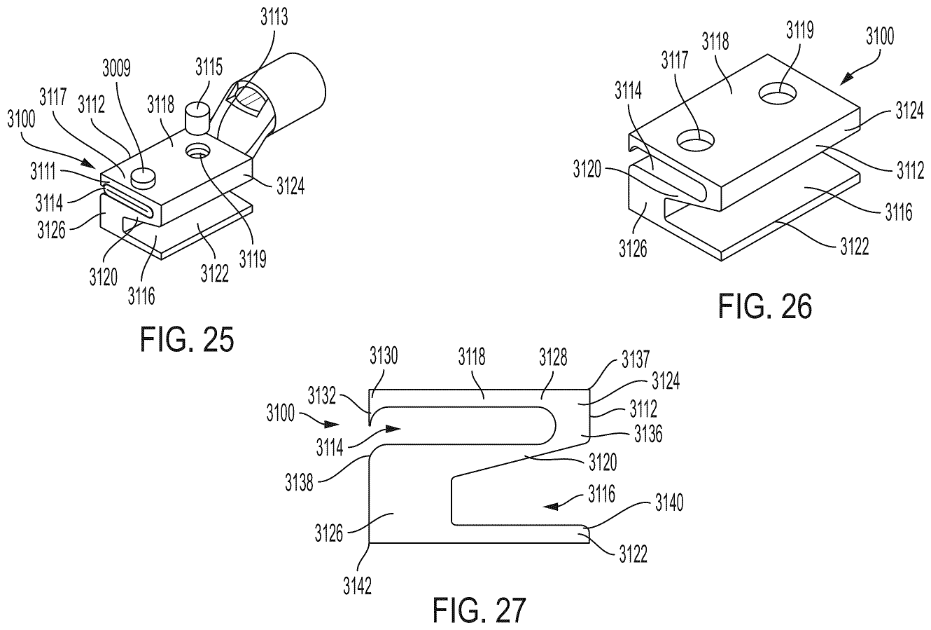

Referring FIGS. 25-27, an eighth embodiment of a compressive terminal pad mounting face according to the present disclosure is shown and is generally referred to by reference numeral 3100 (“mounting 3100”). Mounting 3100 has a mounting body 3112, a first pin 3009 and a second pin 3115. Mounting body 3112 forms a first slot 3114 and a second slot 3116. First slot 3114 is sized to receive a terminal pad 100 that is connected to the conductor. Second slot 3116 is sized to receive the rail 200. Mounting body 3112, first pin 3009 and second pin 3115 are compressible to connect to terminal pad 100 and rail 200 forming a mechanical and electrical connection between terminal pad 100 and rail 200. Mounting body 3112, first pin 3009 and second pin 3115 can be formed of a metal material, for example, annealed 110 copper.

Mounting body 3112 has a top member 3118, a middle member 3120, and a bottom member 3122. Top member 3118 is connected to middle member 3120 by a first side member 3124. Middle member 3120 is connected to bottom member 3122 by a second side member 3126. Top member 3118, middle member 3120, bottom member 3122, first side member 3124 and second side member 3126 form a S-shape having first slot 3114 and second slot 3116 therein. Top member 3118 has a first top edge 3128 that connects with first side member 3124 and a second top edge 3130 that is opposite first top edge 3128 that is free. Top member 3118 has a capture feature 3132 at second top edge 3130 facing middle member 3120. Mounting body 3112 has a first opening 3117 and a second opening 3119 through top member 3118.

Capture feature 3132 extends from top member 3118 so that mounting body 3112 has an increased thickness at capture feature 3132. Middle member 3120 increases in thickness from first side member 3124 to second side member 3126 so that second slot 3116 decreases in size. Second side member 3126 has a greater thickness than first side member 3124. Mounting body 3112 has top corner 3137 and bottom corner 3142. Mounting body 3112 has an inner first edge 3136, an inner middle edge 3138 and an inner second edge 3140 that are all rounded.

In operation, mounting 3100 can be used with terminal pad 100, as shown in FIG. 5, and rail 200, as shown in FIG. 6. Pad portion 104 of terminal pad 100 is inserted between top member 3118, first side member 3124, second side member 3126 and middle member 3120 of mounting 3100. A space between capture feature 3132 and second side member 3126 is too small for pad portion 104 to fit between capture feature 3132 and second side member 3126. Pad portion 104 can be inserted between top member 3118, first side member 3124, second side member 3126 and middle member 3120 of mounting 3100 from a first end 3111 or a second end 3113 of mounting 3100. Alternatively, the space between capture feature 3132 and second side member 3126 may be sized large enough for sliding pad portion 104 between capture feature 3132 and first side member 3124. Second slot 3114 receives rail 200. Second slot 3116 is sized and shaped complementary to rail 200.

Pad portion 104 of terminal pad 100 is inserted between top member 3118, first side member 3124, second side member 3126 and middle member 3120 of mounting 3100 and rail 200 is inserted in second slot 3116. First pin 3009 is inserted into first opening 3117 and second pin 3115 is inserted into second opening 3119 so that a portion of first pin 3009 remains outside of first slot 3114 and first opening 3117, as shown in FIG. 31, and, similarly, a portion of second pin 3115 remains outside of first slot 3114 and second opening 3119. A force is applied to top member 3118, first pin 3009 and second pin 3115 in a first direction A and a force is simultaneously applied to bottom member 3122 in a second direction B that is opposite to direction A to compress and deform mounting body 3112, first pin 3009 and second pin 3115 from a pre-deformed configuration as shown in FIG. 27 to a deformed configuration to connect terminal pad 100 and rail 200 together. First pin 3009 and second pin 3115 are deformed so that the portion of first pin 3009 that remains outside of first slot 3114 and first opening 3117 is deformed to have a size larger than first opening 3117 and the portion of second pin 3115 that remains outside of first slot 3114 and second opening 3119 is deformed to have a size larger than second opening 3119 similar to rivets to hinder removal of first pin 3009 and second pin 3115 from mounting body 3112 after deformed. Capture feature 3132 maintains pad portion 104 of terminal pad 100 in place prior to and after deforming mounting 10 from sliding out of the space between capture feature 3132 and second side member 3126. Mounting body 3112, first pin 3009 and second pin 3115 are deformed around terminal pad 100 and rail 200 so that terminal pad 100 is compressed between top member 3118, first pin 3009, second pin 3115, first side member 3124, middle member 3120 and second side member 3126 maintaining terminal pad 100 in place in mounting 3100 and rail 200 is compressed between bottom member 3122, second side member 3126, middle member 3120 and first side member 3124 to maintain rail 200 in place in mounting. Advantageously, once rail 200 is inserted into second slot 3116, the S-shape of mounting 3100 allows a user to hold mounting 3100 against rail 200 as leverage while pushing terminal pad 100 into first slot 3114 and during compression. The flat surfaces of top member 3118, middle member 3120, first side member 3124, and second side member 3126 provide desirable contact with terminal pad 100 for conduction. Alternatively, a single force could be applied in either direction A against top member 3118, first pin 3009 and second pin 3115 or direction B against bottom member 3122.

Compression of mounting 3100 in first direction A and second direction B to connect terminal pad 100 and rail 200 is achievable by current compression tool technologies, for example, crimping tool 3400 referred to as a Patriot® 15 ton C-head manufactured by Burndy® as shown in FIG. 28 that is used with the dies 3500, 3600 of FIGS. 29 and 30. Crimping tool 3400 has opposite members 3402, 3404. Each of dies 3500, 3600 is placed on one of members 3402, 3404. One of dies 3500, 3600 is placed against top member 3118, first pin 3009 and second pin 3115 and the other of dies 3500, 3600 is placed against bottom member 3122 of mounting 3100, so that crimping tool 3400 is activated to move members 3402, 3404 together to move dies 3500, 3600 together simultaneously in directions C and D to deform mounting body 3112, first pin 3009 and second pin 3115 connecting terminal pad 100 and rail 200.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

PARTS LIST

Compressive terminal pad
mounting face 10
First end 11
Mounting body 12
Second end 13
First slot 14
Second slot 16
Top member 18
Top member 18a
Middle member 20
Bottom member 22
First side member 24
Second side member 26
First side member 24a
Second side member 26a
First top edge 28
Second top edge 30
Capture feature 32
Relief port 34
Terminal pad 100
Receptacle portion 102
Pad portion 104
Rail 200
Compressive terminal pad
mounting face 1100
Curved surface 1102
Curved shape 1104
Corner 1106
Compressive terminal pad
mounting face 1500
Corner 1506
Compressive terminal pad
mounting face 1900
Teeth 1902
Compressive terminal pad
mounting face 2200
First end 2211
Mounting body 2212
Second end 2213
First slot 2214
Second slot 2216
Top member 2218
Middle member 2220
Bottom member 2222
Side member 2224
First top edge 2228
First middle edge 2229
Second top edge 2230
Second middle edge 2231
Capture feature 2232
First bottom edge 2233
Second bottom edge 2235
Compressive terminal pad
mounting face 2500
First end 2511
Mounting body 2512
Second end 2513
First slot 2514
Second slot 2516
First top member 2518
First top member 2518b
Second top member 2519
Second top member
2519b
Middle member 2520
Bottom member 2522
First side member 2524
First side member 2524b
Second side member 2526
First top edge 2528
First top edge 2529
Second top edge 2530
Second top edge 2531
Capture feature 2532
First bottom edge 2533
Relief port 2534
Second bottom edge 2535
Compressive terminal pad
mounting face 3100
Mounting body 3112
First pin 3009
Second End 3113
First slot 3114
Second pin 3115
Second slot 3116First
opening 3117
Top member 3118
Second opening 3119
Middle member 3120
Bottom member 3122
First side member 3124
Second side member 3126
First top edge 3128
Second top edge 3130
Capture feature 3132
Inner first edge 3136
Top corner 3137
Inner middle edge 3138
Inner second edge 3140
Bottom corner 3142
Crimping tool 3400
Opposite members 3402, 3404
Die 3500
Die 3600

What is claimed is:

1. A mounting assembly comprising:
a mounting body having a first slot and a second slot;
a terminal pad being in the first slot; and
a rail being in the second slot, the mounting body being deformed around the terminal pad and the rail so that a mechanical and electrical connection is formed between the terminal pad and the rail.

2. The mounting of claim 1, wherein the mounting body forms an S-shape.

3. The mounting of claim 2, wherein the mounting body forms a top member connected to a first side member on a first side and the top member having a free end opposite the first side member, wherein the first side member is connected to a middle member on a side opposite the top member and the middle member is connected to a second side member on a side opposite the first side member, wherein the second side member is connected to a bottom member on a side that is opposite the middle member, and wherein the bottom member has a free end on a side opposite the second side member.

4. The mounting of claim 3, wherein the first slot is formed in the top member, the first side member, the middle member and the second side member.

5. The mounting of claim 3, wherein the second slot is formed in the first side member, the middle member, the second side member and the bottom member.

6. The mounting of claim 3, wherein the top member has a capture feature that extends from the free end of the top member into the second slot.

7. The mounting of claim 3, wherein the top member has a release port formed in the first slot, and wherein the top member has a thickness that is reduced at the release port.

8. The mounting of claim 3, wherein the middle member has a thickness that increase from the first side member to the second side member.

9. The mounting of claim 6, wherein the top member forms a space between the capture feature and the second side member that is smaller than the terminal pad.

10. The mounting of claim 3, wherein the top member is flat on a surface opposite the first slot.

11. The mounting of claim 3, wherein the top member is curved on a surface opposite the first slot.

12. The mounting of claim 3, wherein the mounting body has teeth formed inside the second slot on the middle member and the bottom member.

13. The mounting of claim 3, wherein the top member has at least one opening that receives a pin.

14. The mounting of claim 1, wherein the mounting member has an E-shape.

15. The mounting of claim 1, wherein the mounting body has a first side member and a second side member on opposite sides of a middle member with a first top member extending from the first side member and a second top member extending from the second side member forming the first slot, and wherein the mounting body has a bottom member extending from the second side member so that the bottom member, the second side member, the middle member and the first side member form the second slot.

16. The mounting of claim 15, wherein the first top member and the second top member are curved.

17. A method for connecting a terminal pad to a rail comprising:
inserting a terminal pad in a first slot of a mounting body;
inserting a rail in a second slot of the mounting body; and
deforming the mounting body around the terminal pad and the rail so that a mechanical and electrical connection is formed between the terminal pad and the rail.

18. The method of claim 17, further comprising contacting the mounting body with a first die and contacting the mounting with a second die prior to the deforming of the mounting body.

19. A die set comprising:
a first die for connecting to a crimping tool, the first die configured to contact a first side of a mounting body; and
a second die for connecting to the crimping tool, the second die configured to contact a second side of a mounting body so that the first die and the second die apply forces in opposite directions to compress and deform the mounting body around a terminal pad and a rail forming a mechanical and electrical connection between the terminal pad and the rail.
